(19) United States
(12) Patent Application Publication
(10) Pub. No.: US 2016/0126538 A1
(43) Pub. Date: May 5, 2016

(54) ELECTRODE MATERIAL AND USE THEREOF IN LITHIUM ION BATTERIES

(71) Applicant: Wacker Chemie AG, Muenchen (DE)

(72) Inventors: Eckhard HANELT, Geltendorf (DE); Stefan HAUFE, Neubiberg (DE)

(21) Appl. No.: 14/895,274

(22) PCT Filed: Jun. 16, 2014
(86) PCT No.: PCT/EP2014/062565

§ 371 Date: Dec. 2, 2015

(30) Foreign Application Priority Data
Jun. 18, 2013 (DE) 10 2013 211 388.9

(51) Int. Cl. H01M 4/134; H01M 10/0525; H01M 4/587; H01M 4/62; H01M 4/38; H01M 4/60

(52) U.S. Cl. CPC H01M 4/134; H01M 4/386; H01M 4/60; H01M 4/587; H01M 4/621; H01M 4/625; H01M 4/626; H01M 10/0525; H01M 2004/027

(57) ABSTRACT

The invention relates to an electrode material for lithium ion batteries, comprising 5-85% by weight of nanoscale silicon particles, which are not aggregated and of which the volume-weighted particle size distribution is between the diameter percentiles d₁₀>20 nm and d₉₀<2000 nm and has a breadth d₉₀-d₁₀<1200 nm; 0-40% by weight of an electrically conductive component containing nanoscale structures with expansions of less than 800 um; 0-80% by weight of graphite particles with a volume-weighted particle size distribution between the diameter percentiles d₁₀>0.2 μm and d₉₀<200 μm; 5-25% by weight of a binding agent; wherein a proportion of graphite particles and electrically conductive components produces in total at least 10% by weight, wherein the proportions of all components produce in total a maximum of 100% by weight.

The invention relates to an electrode material and the use thereof in lithium ion batteries.

In anodes for lithium ion batteries, in which the electrode active material is based on silicon (as material having the highest known storage capacity for lithium ions; 4199 mAh/g), the silicon can experience an extreme volume change of up to about 300% during loading with or discharge of lithium. This volume change results in severe mechanical stress on the active material and the total electrode structure, which leads via electrochemical milling to a loss of electric contacting and hence destruction of the electrode with a loss of capacity. Furthermore, the surface of the silicon anode material used reacts with constituents of the electrolyte with continuous formation of passivating protective layers (solid electrolyte interface; SEI), which leads to an irreversible loss of lithium.

Rechargeable lithium ion batteries are today the practically usable electrochemical energy stores having the highest energy densities of up to 180 Wh/kg. They are used first and foremost in the field of portable electronics, for tools and also for transport means, for example bicycles or automobiles. However, particularly for use in automobiles, it is necessary to achieve a further significant increase in the energy density of the batteries in order to obtain longer ranges of the vehicles.

As negative electrode material (“anode”), use is made mainly of graphitic carbon. The graphitic carbon is characterized by its stable cycling properties and its quite high safety on handling compared to lithium metal, which is used in primary lithium cells. An important argument for the use of graphitic carbon in negative electrode materials is the low volume changes in the host material associated with the intercalation and deintercalation of lithium, i.e. the electrode remains almost stable. Thus, a volume increase of only about 10% is measured for the limiting stoichiometry of LiC₆ when lithium is intercalated into graphitic carbon. However, a disadvantage is its relatively low electrochemical capacity of theoretically 372 mAh/g of graphite, which is only about one tenth of the electrochemical capacity which can theoretically be achieved using lithium metal.

For this reason, research to find alternative materials has been carried out for a long time, especially in the field of alloys. These anode materials offer the advantage over metallic lithium that no dendrite formation occurs during the deposition of lithium. In contrast to graphite materials, anode materials based on alloys are suitable for use together with electrolytes based on propylene carbonate. This makes it possible to use lithium ion batteries at low temperatures. However, these alloys have the disadvantage of a large volume expansion during intercalation and deintercalation of lithium, which is more than 200% and sometimes even up to 300%.

Silicon forms, together with lithium, binary electrochemically active compounds which have a very high lithium content. The theoretical maximum lithium content is found in the case of Li_{4.4}Si, which corresponds to a very high theoretical specific capacity of about 4200 mAh/g of silicon. As in the case of the abovementioned binary alloys, the intercalation and deintercalation of lithium is also associated with a very large volume expansion, which is a maximum of 300%, in the case of silicon, too. This volume expansion leads to severe mechanical stress on the crystallites and as a result to fragmentation of the particles with loss of electric contact.

The mechanical stress can be substantially reduced when electrode materials containing nanosize silicon particles are used. However, very different statements regarding the optimal size and shape of the nanosize silicon particles in the electrode materials have been published in the literature. These are partly based on experimental results or on theoretical calculations. In many cases, the assessment was also dependent, in particular, on which particle sources were in each case available for the production of the electrode materials. Experiments using mixtures of nanosize silicon and carbon black have also been described; these give a significantly improved electrical conductivity of the electrodes produced therefrom and display a very high capacity of initially up to over 2000 mAh/g, although this decreases significantly over a plurality of charging and discharging cycles. This decrease is referred to in the literature as fading and irreversible loss of capacity.

EP 1730800 B1 discloses an electrode material for lithium ion batteries, characterized in that the electrode material comprises 5-85% by weight of nanosize silicon particles which have a BET surface area of from 5 to 700 m²/g and an average primary particle diameter of from 5 to 200 nm, 0-10% by weight of conductive carbon black, 5-80% by weight of graphite having an average particle diameter of from 1 μm to 100 μm and 5-25% by weight of a binder, where the proportions of the components add up to a maximum of 100% by weight.

EP 1859073 A1 discloses a process for producing coated carbon particles, characterized in that electrically conductive carbon particles are coated with elementary doped or undoped silicon by chemical vapor deposition from at least one gaseous silane in an oxygen-free gas atmosphere in a reaction space, where the electrically conductive carbon particles are continually in motion during the vapor deposition.

These coated carbon particles can, together with graphite particles, binders and a conductivity improver, form an anode material.

EP 2364511 A1 discloses a process for producing active material for the electrode of an electrochemical element, which comprises the steps
provision of carbon particles,
application of a silicon precursor to the surface of the carbon particles,
thermal decomposition of the silicon precursor to form metallic silicon.

The electrochemical active material, especially for the negative electrode of an electrochemical element, comprises carbon particles whose surface is at least partly covered with a layer of silicon, in particular a layer of amorphous silicon.

EP2573845 A1 describes a process for producing active material for the electrode of an electrochemical cell, which comprises the steps
provision of lithium-intercalating carbon particles having an average particle size in the range from 1 μm to 100 μm as component 1,
provision of silicon particles having an average particle size in the range from 5 nm to 500 nm as component 2,
provision of a polymer or polymer precursor which can be pyrolyzed to amorphous carbon, as component 3,
mixing of the components 1 to 3 and
heat treatment of the mixture in the absence of atmospheric oxygen at a temperature at which the pyrolyzable polymer or the pyrolyzable polymer precursor decomposes to form amorphous carbon.

The electrochemical active material produced, in particular for the negative electrode of an electrochemical cell, comprises lithium-intercalating carbon particles whose surface is at least partly covered with a layer of amorphous carbon, with silicon particles having an average particle size in the range from 5 nm to 500 nm being embedded in the layer.

JP 2003109590 A2 discloses a negative electrode material containing polycrystalline silicon powder which is doped with phosphorus, boron or aluminum.

WO 13040705 A1 discloses a process for producing particulate material for use in anodes, which comprises dry milling of particles composed of an element of the carbon-silicon group to form microsize particles, wet milling of the microsize particles dispersed in a solvent to give nanosize particles (10-100 nm). The disclosure provides for the nanoparticles to be mixed with a carbon precursor and the mixture to be pyrolyzed in order to coat the nanoparticles at least partly with conductive carbon.

A process for producing Si nanoparticles which has been known for a long time is wet milling of a suspension of Si particles in organic solvents by means of a stirred ball mill (T. P. Herbell, T. K. Glasgow and N. W. Orth, “Demonstration of a silicon nitride attrition mill for production of fine pure Si and Si3N4 powders”; Am. Ceram. Soc. Bull., 1984, 63, 9, p. 1176). In this publication, it is said that reactions of the material being milled with the suspension liquid can take place during milling.

U.S. Pat. No. 7,883,995 B2 claims a process for producing stable functionalized nanoparticles smaller than 100 nm, with the particles being functionalized in a reactive medium during milling in a ball mill. Alkenes, in particular, are used for functionalizing the particle surface because the double bonds can react particularly easily with open bonds on the fracture surfaces of the particles.

EP 1102340 A2 discloses a process for producing anode material containing silicon, which comprises crushing of silicon in an atmosphere having an oxygen partial pressure which is more than 10 Pa and is lower than the oxygen partial pressure of air.

It was an object of the present invention to provide an electrode material which has a high reversible capacity, with only slight fading and/or lower irreversible decreases in capacity during the first cycle preferably being achieved at the same time.

In particular, it was an object to provide an electrode material which has satisfactory mechanical stability during repeated charging and discharging.

For the purposes of the present invention, fading is the decrease in the reversible capacity during continued cycling.

It has surprisingly been found that an electrode material containing nanosize silicon particles which are not aggregated and whose volume-weighted particle size distribution lies between the diameter percentiles d₁₀>20 nm and d₉₀<2000 nm and has a width d₉₀-d₁₀ of <1200 nm,

leads to good cycling behavior, particularly compared to silicon-based negative electrodes for lithium ion batteries as per the prior art.

The achievement of the object in this way was all the more surprising because these electrodes have a very high reversible capacity which also remains approximately constant over the course of cycling, so that only slight fading is observed. Furthermore, it was found that the use of these nanosize silicon particles leads to the electrode material having a significantly improved mechanical stability.

It was likewise surprising that the irreversible decrease in capacity during the first cycle could be reduced. This is, as can also be seen from the examples and comparative examples, attributable to the use of unaggregated silicon particles in the electrode material.

To achieve these improved properties over the long term, it is necessary to define the required width of the particle size distributions. This is achieved by means of the percentiles d₁₀ and d₉₀ specified here for the particle size distributions, but not by means of the BET values and average particle diameters which are usually indicated.

The percentile d₉₀ is particularly relevant for the layer thickness of an electrode because it determines the minimum electrode thickness. Particles which are too large can lead to short circuits between the negative electrode and the positive electrode. Particles which are too small contribute less to the electrode capacity.

The object of the invention has been achieved by an electrode material for a lithium ion battery according to any of claims 1 to 7, the use thereof in a lithium ion battery and by a lithium ion battery having a negative electrode comprising the electrode material of the invention.

Electrodes in which the electrode material of the invention is used have a very high reversible capacity. This applies both to the electrode material according to the invention having a high content of nanosize silicon particles and to the electrode material according to the invention having a low content of nanosize silicon particles.

This reversible capacity remains approximately constant during the course of cycling too, so that only slight fading is observed.

Furthermore, the electrode material of the invention has a good stability. This means that virtually no fatigue phenomena, for example mechanical destruction of the electrode material of the invention, occur even during prolonged cycling.

The irreversible decrease in capacity during the first cycle can be reduced when using the electrode material of the invention compared to corresponding silicon-containing and alloy-based electrode materials for lithium ion batteries as per the prior art. In general, the electrode material of the invention displays good cycling behavior.

For the purposes of the present invention, an electrode material is a material or a mixture of two or more materials which allow(s) electrochemical energy to be stored in a battery by means of oxidation and/or reduction reactions. Depending on whether the electrochemical reaction which provides energy in the charged battery is an oxidation or reduction, the material is referred to as a negative or positive electrode material or else anode or cathode material.

The electrode material of the invention consists of a preferably homogeneous mixture of unaggregated silicon particles, graphite, a nanosize electrically conductive component, a binder and optionally further components or auxiliaries such as pore formers, dispersants or dopants (e.g. elemental lithium).

The unaggregated silicon particles can consist of elemental silicon, a silicon oxide or a binary, ternary or multinary silicon-metal alloy (comprising, for example, Li, Na, K, Sn, Ca, Co, Ni, Cu, Cr, Ti, Al, Fe).

Preference is given to using elemental silicon since this has the greatest storage capacity for lithium ions.

For the purposes of the present invention, elemental silicon is high-purity polysilicon, silicon deliberately doped with small proportions of foreign atoms (for example B, P, As) or else metallurgical silicon which can have elemental contamination (for example Fe, Al, Ca, Cu, Zr, C).

If the silicon particles contain a silicon oxide, the stoichiometry of the oxide SiOₓ is preferably in the range 0<x<1.3. If the silicon particles contain a silicon oxide having a higher stoichiometry, the layer thickness of this on the surface is preferably less than 10 nm.

When the unaggregated silicon particles are alloyed with an alkali metal M, then the stoichiometry of the alloy MₓSi is preferably in the range 0<x<5.

Particular preference is given to unaggregated nanosize silicon particles which in the interior contain more than 80 mol % of silicon and less than 20 mol % of foreign atoms, very particularly preferably less than 10 mol % of foreign atoms.

The surface of the nanosize silicon particles, on the other hand, can be covered by an oxide layer or by other inorganic and organic groups, depending on the production process.

Particularly preferred unaggregated nanosize silicon particles bear Si—OH or Si—H groups or covalently bound organic groups such as alcohols or alkenes on the surface.

The unaggregated nanosize silicon particles can be produced by the known methods of vapor deposition or by milling processes.

Nanoparticles produced by gas-phase processes typically have a round or acicular shape.

In contrast, the particles produced by milling processes have fracture surfaces, sometimes sharp-edged fracture surfaces. They are typically splinter-shaped.

The sphericity ψ according to the definition of Wadell is the ratio of the surface area of a sphere of the same volume to the actual surface area on a body.

The splinter-shape silicon particles produced by milling processes have a sphericity of typically 0.3<ψ<0.9.

The silicon particles preferably have a sphericity of 0.5<ψ<0.85, particularly preferably 0.65<ψ<0.85.

The international standard of the “Federation Europeenne de la Manutention” gives, in FEM 2.581, an overview of the aspects under which a bulk material should be regarded. The standard FEM 2.582 defines the general and specific bulk material properties in respect of classification. Parameters which describe the consistency and the state of the material are, for example, particle shape and particle size distribution (FEM 2.581/FEM 2.582: General characteristics of bulk products with regard to their classification and their symbolization).

According to DIN ISO 3435, bulk materials can be subdivided into 6 different particle shapes as a function of the nature of the particle edges:

I Sharp edges with approximately equal measurements in the three dimensions (e.g.: cube)

II Sharp edges of which one is significantly longer than the other two (e.g. prism, blade)

III Sharp edges of which one is significantly shorter than the other two (e.g. plate, flakes)

IV Round edges having approximately equal measurements in the three dimensions (e.g. sphere)

V Round edges, in one direction significantly larger than in the other two (e.g. cylinder, rod)

VI Fibrous, thread-like, curl-like, entangled

According to this classification of bulk materials, the silicon particles produced by milling processes are preferably particles having the particle shapes I, II or III.

Different statements regarding the optimal size of the nanosize silicon particles in an electrode material have been published in the literature in the past. In many cases, the assessment depended on which particle sources were in each case available for producing the electrodes. Vapor deposition typically produces particles whose diameter is smaller than 100 nm, while the range above 100 nm is more readily accessible in the case of milling.

The silicon particles used for the purposes of the invention are not aggregated, and their volume-weighted particle size distribution lies between the diameter percentiles d₁₀>20 nm and d₉₀<2000 nm and has a width d₉₀-d₁₀ of <1200 nm.

The particle size distribution particularly preferably lies between d₁₀>30 nm and d₉₀<1000 nm and has a width d₉₀-d₁₀ of <600 nm, with very particular preference being given to d₁₀>40 nm and d₉₀<500 nm and d₉₀-d₁₀<300 nm.

To avoid aggregation of the particles during vapor deposition, only low gas concentrations or residence times in the reactor can be used, so that the yield of unaggregated nanosize silicon particles is typically significantly lower than in the case of conventional gas-phase processes on the industrial scale.

To achieve high yields and thus satisfactory economics of the production process, the unaggregated nanosize silicon particles are therefore preferably produced by milling processes.

For use in an electrode material, Si nanoparticles which are functionalized on the surface by covalently bound organic groups are particularly suitable because the surface tension of the particles can be optimally matched to the solvents and binders used for production of the electrode coatings by means of such functionalization.

For milling the nanosize silicon particles in a suspension, it is possible to use various organic or inorganic liquids or liquid mixtures having a viscosity at room temperature of preferably less than 100 mPas and particularly preferably less than 10 mPas.

The liquid is preferably inert or only slightly reactive toward silicon.

The liquid is particularly preferably organic and contains less than 5% of water, particularly preferably less than 1% of water.

The liquids preferably contain polar groups. Particular preference is given to alcohols.

In the production of the unaggregated nanosize silicon particles by wet milling in a suspension, preference is given to using milling media whose average diameter is from 10 to 1000 times larger than the d₉₀ of the distribution of the material to be milled. Particular preference is given to milling media whose average diameter is from 20 to 200 times greater than the d₉₀ of the initial distribution of the material being milled.

In order to reduce the transition resistances within the electrode and between electrode and power outlet lead, the electrode material of the invention can contain 0-40% by weight of an electrically conductive component having nanosize structures of <800 nm. The electrode material preferably contains 0-30% by weight, particularly preferably 0-20% by weight, of this electrically conductive component.

A preferred electrically conductive component having nanosize structures is a conductive carbon black containing primary particles which have a volume-weighted particle size distribution between the diameter percentiles d₁₀=5 nm and d₉₀=200 nm and which may be branched in a chain-like manner and form structures having a size up to the μm range.

Another preferred electrically conductive component having nanosize structures is carbon nanotubes having a diameter of from 0.4 to 200 nm.

Particularly preferred carbon nanotubes have a diameter of from 2 to 100 nm, very particularly preferably a diameter of from 5 to 30 nm.

When carbon nanotubes are used as electrically conductive components in the electrode material, it has to be ensured that these are very well dispersed in a suitable solvent before use in an electrode ink or paste so that they become uniformly distributed in the electrode material and especially on the surface of the Si nanoparticles.

A third preferred electrically conductive component is metallic nanoparticles having a volume-weighted particle size distribution which lies between the diameter percentiles d₁₀=5 nm and d₉₀=800 nm. Particularly preferred metallic nanoparticles contain copper.

Preferred binders are polyvinylidene fluoride, polytetrafluoroethylene, polyolefins and thermoplastic elastomers, in particular ethylene-propylene-diene terpolymers. In a particular embodiment, modified cellulose is used as binder.

The processing of the components of the electrode material of the invention to form an electrode ink or paste can be carried out in a solvent, e.g. water, hexane, toluene, tetrahydrofuran, N-methylpyrrolidone, N-ethylpyrrolidone, acetone, ethyl acetate, dimethyl sulfoxide, dimethyl acetamide or ethanol or solvent mixtures, using rotor-stator machines, high-energy mills, planetary kneaders, stirred ball mills, shaking tables or ultrasonic apparatuses.

The electrode ink or paste is preferably applied in a dry layer thickness of from 2 μm to 500 μm, particularly preferably from 10 μm to 300 μm, to a copper foil or another current collector by means of a doctor blade.

Other coating methods such as spin coating, dip coating, painting or spraying can likewise be used.

Before coating the copper foil with the electrode material of the invention, the copper foil can be treated with a commercially available primer, e.g. on the basis of polymer resins. This increases the adhesion to the copper but itself has virtually no electrochemical activity.

The electrode material is dried to constant weight. The drying temperature depends on the components used and the solvent employed. It is preferably in the range from 20° C. to 300° C., particularly preferably from 50° C. to 150° C.

The present invention provides a lithium ion battery having a negative electrode containing the electrode material of the invention.

Such a lithium ion battery comprises a first electrode as cathode, a second electrode as anode, a membrane arranged between the two electrodes as separator, two connections to the electrodes, a housing which accommodates the specified parts and also a lithium ion-containing electrolyte with which the two electrodes have been impregnated, wherein part of the second electrode contains the electrode material of the invention.

As preferred cathode materials, it is possible to use Li foil, lithium cobalt oxide, lithium nickel oxide, lithium nickel cobalt oxide (doped and undoped), lithium manganese oxide (spinel), lithium nickel cobalt manganese oxides, lithium nickel manganese oxides, lithium iron phosphate, lithium cobalt phosphate, lithium manganese phosphate, lithium vanadium phosphate or lithium vanadium oxides.

The separator is an electrically insulating membrane which is permeable to ions, as is known in battery production. The separator separates the first electrode from the second electrode.

The electrolyte is a solution of a lithium salt (=electrolyte salt) in an aprotic solvent. Electrolyte salts which can be used are, for example, lithium hexafluorophosphate, lithium hexafluoroarsenate, lithium perchlorate, lithium tetrafluoroborate, LiCF₃SO₃, LiN(CF₃SO₂) or lithium borates.

The concentration of the electrolyte salt is preferably in the range from 0.5 mol/l to the solubility limit of the respective salt. It is particularly preferably from 0.8 mol/l to 1.2 mol/l.

As solvents, it is possible to use cyclic carbonates, propylene carbonate, ethylene carbonate, dimethyl carbonate, diethyl carbonate, ethyl methyl carbonate, dimethoxyethane, diethoxyethane, tetrahydrofuran, 2-methyltetrahydrofuran, gamma-butyrolactone, dioxolane, acetonitrile, organic carbonic esters or nitriles, either individually or as mixtures thereof.

The electrolyte preferably contains a film former such as vinylene carbonate, fluoroethylene carbonate, etc., by which means a significant improvement in the cycling stability of the Si composite electrode can be achieved. This is mainly attributed to formation of a solid electrolyte intermediate phase on the surface of active particles. The proportion of the film former in the electrolyte is in the range from 0.1% by weight to 20.0% by weight, preferably from 0.2% by weight to 15.0% by weight, particularly preferably from 0.5% by weight to 10% by weight.

In order to match the actual capacities of the electrodes of a lithium ion cell to one another as optimally as possible, an attempt is made to balance the materials for the positive and negative electrode in terms of quantity. In this context, it is particularly important that the first or initial charging/discharging cycle of secondary lithium ion cells (known as activation) results in formation of a covered layer on the surface of the electrochemically active materials in the anode. This covering layer is referred to as “solid electrolyte interphase” (SEI) and generally consists mainly of electrolyte decomposition products and also a certain amount of lithium which is accordingly no longer available for further charging/discharging reactions.

A loss of from about 10% to 35% of the mobile lithium usually occurs during the first charging step, depending on the type and quality of the active material used and on the electrolyte solution used. The achievable reversible capacity also drops by this percentage. These activation losses have to be taken into account when balancing anode and cathode.

Negative electrodes having the electrode material of the invention are characterized in that the initial loss of mobile lithium is less than 30% of the reversible capacity in the first cycle, preferably less than 20%, particularly preferably less than 10%.

The lithium ion battery of the invention can be produced in all customary shapes in rolled, folded or stacked form.

All substances and materials utilized for producing the lithium ion battery of the invention, as described above, are known. The production of the parts of the battery of the invention and the assembly of these to give the battery of the invention is carried out by methods known in the field of battery manufacture.

The invention is illustrated below with the aid of examples and FIG. 1-7.

### BRIEF DESCRIPTION OF THE FIGURES

FIG. 1 shows the scanning electron micrograph of a powder sample of milled Si particles.

FIG. 2 shows the dependence of the charging and discharging capacity of the electrode coating as a function of the number of cycles.

FIG. 3 shows the scanning electron micrograph of an electrode coating according to the invention.

FIG. 4 shows the scanning electron micrograph of an electrode coating according to the invention after the first charging/discharging cycle.

FIG. 5 shows the dependence of the charging and discharging capacity of an electrode coating according to the invention as a function of the number of cycles.

FIG. 6 shows the scanning electron micrograph of aggregated Si nanoparticles.

FIG. 7 shows the dependence of the charging and discharging capacity of an electrode coating containing aggregated Si nanoparticles as a function of the number of cycles.

### EXAMPLES

Example 1 relates to the production of splinter-shaped nanosize silicon particles by milling.

A mixture was produced of 79 g of ethanol (purity 99%) and 50 g of a milled fine dust composed of pure silicon having a particle distribution with d₁₀=13 μm, d₅₀=59 μm and d₉₀=140 μm, which can be produced from coarser silicon particles on an industrial scale according to the prior art using a fluidized-bed jet mill. This mixture was stirred for 20 minutes until all of the solid was finely dispersed in the suspension. 93 ml of yttrium oxide-stabilized zirconium oxide milling beads having an average diameter of 0.8-1 mm were placed in a 250 ml milling cup lined with zirconium oxide. The suspension composed of silicon dust and ethanol was subsequently poured into the milling cup and the milling cup was firmly closed under nitrogen as protective gas. The milling cup was placed in a Retsch planetary ball mill PM 100 and then agitated at a speed of rotation of 400 rpm for 240 minutes. After the milling operation, the milling cup was emptied into a sieve having a mesh opening of 0.5 mm in order to separate the suspension containing the milled Si particles from the milling beads. Ethanol was added to the suspension so that the solids concentration of the suspension was subsequently 18.7% by weight.

Measurement of the particle distribution by static laser light scattering using a Horiba LA 950 gave d₁₀=120 nm, d₅₀=190 nm and d₉₀=290 nm in a greatly diluted suspension in ethanol.

About 5 ml of the suspension were dried at 120° C. and 20 mbar in a vacuum drying oven for 16 hours.

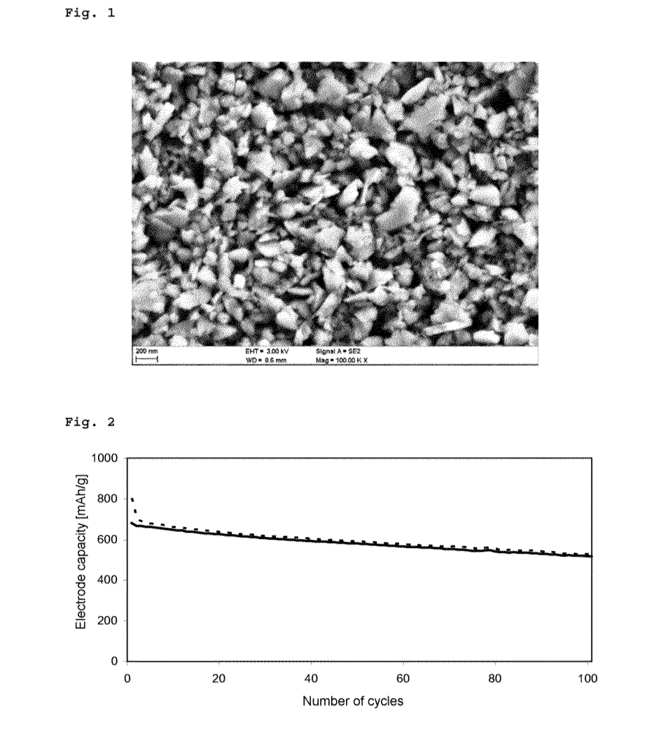

The scanning electron micrograph of the dry Si dust in FIG. 1 shows that the sample consists of individual, unaggregated, splinter-shaped particles.

Part of the dry Si dust was processed using a diamond punch to give a pressed body. The infrared absorption of this pressed body was measured in an FTIR spectrometer. The absorption spectrum displays a pronounced band at 1100 cm⁻¹, which is characteristic of Si—O—C bonds. It can be concluded therefrom that ethanol is covalently bound to the Si surface.

Example 2 illustrates the production of electrodes using the material from example 1, graphite, conductive carbon black and binder by physical mixing.

4.28 g of the 18.7% strength by weight Si suspension in ethanol as per example 1 and 0.48 g of conductive carbon black (Timcal, Super P Li) were dispersed in 24.32 g of a 1.3% by weight solution of sodium carboxymethylcellulose (Daicel, Grade 1380) in water by means of a high-speed mixer at a circumferential velocity of 4.5 m/s at 20° C. for 15 minutes while cooling. After addition of 2.41 g of graphite (Timcal, SFG6), the mixture was then stirred at a circumferential velocity of 17 m/s for 45 minutes. After degassing, the dispersion was applied by means of a film drawing frame having a gap height of 0.10 mm (Erichsen, model 360) to a copper foil (Schlenk Metallfolien, SE-Cu58) having a thickness of 0.030 mm. The electrode coating produced in this way was subsequently dried at 80° C. and 1 bar atmospheric pressure for 60 minutes. The average weight per unit area of the dry electrode coating was 0.90 mg/cm².

Example 3 relates to the testing of electrodes from example 2.

The electrochemical tests were carried out on a half cell in a three-electrode arrangement (zero-current potential measurement). The electrode coating from example 2 was used as working electrode, and lithium foil (Rockwood lithium, thickness 0.5 mm) was used as reference electrode and counterelectrode. A 6-layer nonwoven stack (Freudenberg Vliesstoffe, FS2226E) impregnated with 100 μl of electrolyte served as separator. The electrolyte used consisted of a 1 molar solution of lithium hexafluorophosphate in a 3:7 (v/v) mixture of ethylene carbonate and diethyl carbonate which had been admixed with 2% by weight of vinylene carbonate. The construction of the cell was carried out in a glove box (<1 ppm H₂O, O₂), and the water content in the dry mass of all components used was below 20 ppm.

The electrochemical testing was carried out at 20° C. The limits used for the potential were 40 mV and 1.0 V vs. Li/Li⁺. The charging and lithiation of the electrode was carried out using the cc/cv (constant current/constant voltage) method with a constant current and, after reaching the voltage limit, with constant voltage until the current dropped below 50 mA/g. The discharging or delithiation of the electrode was carried out using the cc (constant current) method with a constant current until the voltage limit had been reached. The specific current selected was based on the weight of the electrode coating.

FIG. 2 shows the charging (broken line) and discharging capacity (solid line) of the electrode coating from example 2 as a function of the number of cycles at a current of 100 mA/g. The electrode coating from example 2 has a reversible initial capacity of about 700 mAh/g and after 100 charging/discharging cycles still has about 80% of its original capacity.

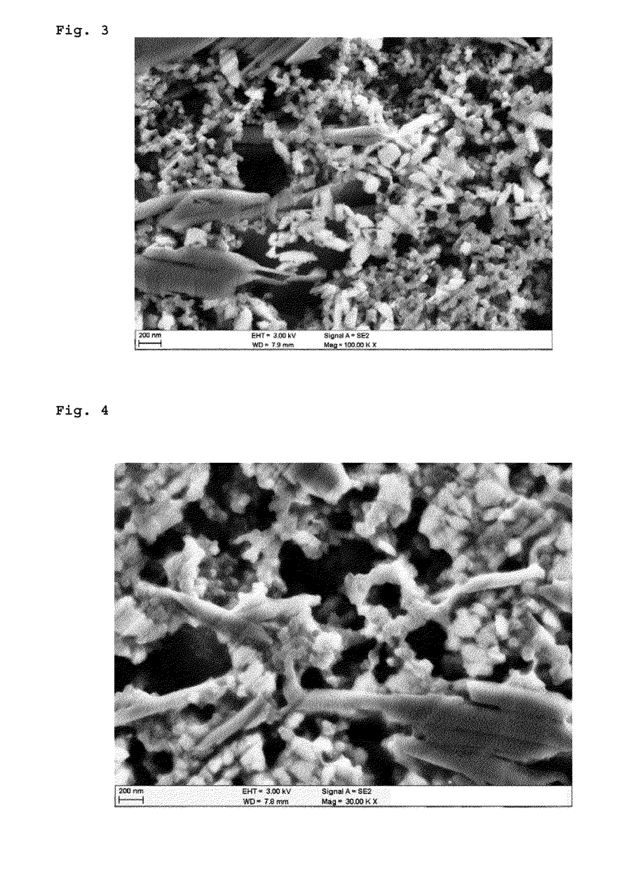

FIG. 3 shows the scanning electron micrograph of the cross section of the electrode coating from example 2 and FIG. 4 shows the scanning electron micrograph of the cross section of the electrode coating from example 2 after the first charging/discharging cycle.

The splinter-shaped nanosize silicon particles can clearly be seen in all scanning electron micrographs. The silicon particles are present in unaggregated form even after charging and discharging or lithiation and delithiation.

Example 4 illustrates the production of splinter-shaped nanosize silicon particles by milling.

A mixture of 2 kg of ethanol (purity 99%) and 500 g of a milled fine dust composed of pure silicon having a particle distribution with d₁₀=8 μm, d₅₀=15 μm and d₉₀=25 μm, which can be produced from coarser particles on an industrial scale according to the prior art using a fluidized-bed jet mill was produced and stirred for 20 minutes until all of the solid was finely dispersed in the suspension. The milling space of a laboratory stirred ball mill Netzsch LabStar LS1 having the ZETA Keramik milling system was charged with 490 ml of yttrium oxide-stabilized zirconium oxide milling beads having an average diameter of 0.3 mm and closed. The suspension composed of silicon dust and ethanol was subsequently introduced into the cooled reservoir of the mill and circulated by pumping through the mill at a throughput of 40 kg/h. The particles in the suspension were milled at a speed of rotation in the mill of 3000 rpm for 245 minutes. The subsequent measurement of the particle distribution by static laser light scattering using a Horiba LA 950 gave a size distribution with d₁₀=80 nm, d₅₀=150 nm and d₉₀=290 nm in a greatly diluted suspension in ethanol. The scanning electron micrographs showed that the sample consisted of individual, unaggregated, splinter-shaped particles similar to those in FIG. 1. Compared to example 1, this method offers the advantage that relatively large amounts of Si nanoparticles of from a few kg through to the industrial scale can be produced.

Example 5 relates to the production and testing of electrodes comprising the splinter-shaped nanosize silicon particles from example 4.

In a manner analogous to example 2, electrodes were produced using the splinter-shaped nanosize silicon particles from example 4 and tested as described in example 3.

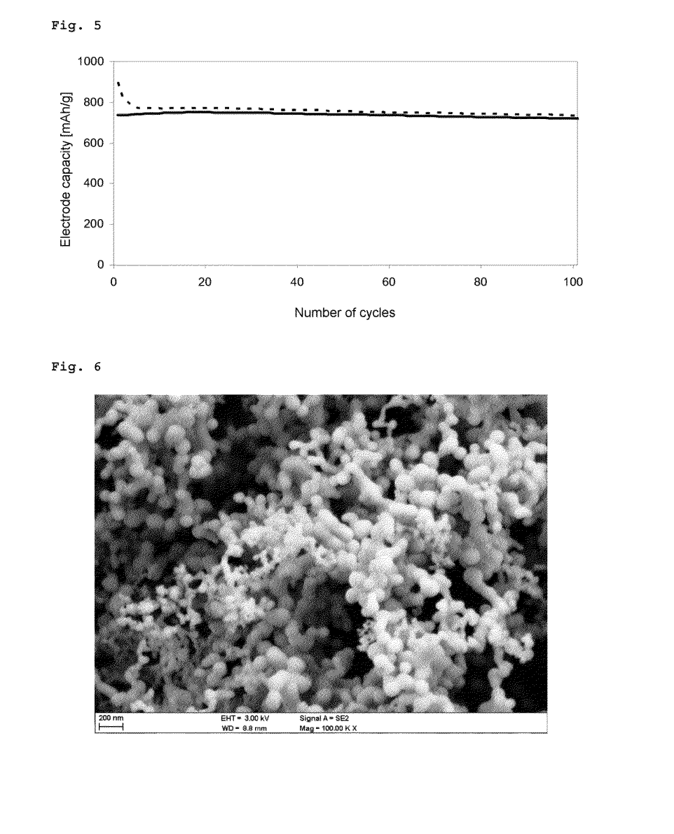

FIG. 5 shows the charging (broken line) and discharging capacity (solid line) of this electrode coating comprising the splinter-shaped nanosize silicon particles from example 4 as a function of the number of cycles at a current of 100 mA/g.

The electrode coating comprising the splinter-shaped nanosize silicon particles from example 4 has a reversible initial capacity of about 750 mAh/g and after 100 charging/discharging cycles still has about 97% of its original capacity.

The scanning electron micrographs showed, in a manner similar to FIG. 3 and FIG. 4, that the silicon particles are present in unaggregated form even after charging and discharging or lithiation and delithiation.

(Comparative) example 6 relates to the production and electrochemical characterization of an electrode coating comprising aggregated silicon particles (not according to the invention).

0.80 g of aggregated Si nanoparticles having a primary particle size of 20-30 nm (manufactured by Nanostructured & Amorphous Materials, Inc., see FIG. 6) and 0.48 g of conductive carbon black (Timcal, Super P Li) were dispersed in 24.32 g of a 1.3% by weight solution of sodium carboxymethylcellulose (Daicel, Grade 1380) in water by means of a high-speed mixer at a circumferential velocity of 4.5 m/s at 20° C. while cooling. After addition of 2.41 g of graphite (Timcal, SFG6), the mixture was then stirred at a circumferential velocity of 17 m/s for 45 minutes. After degassing, the dispersion was applied by means of a film drawing frame having a gap height of 0.10 mm (Erichsen, model 360) to a copper foil (Schlenk Metallfolien, SE-Cu58) having a thickness of 0.030 mm. The electrode coating produced in this way was subsequently dried at 80° C. for 60 minutes. The average weight per unit area of the dry electrode coating was 0.78 mg/cm².

FIG. 6 shows a scanning electron micrograph of the aggregated Si nanoparticles having a primary particle size of 20-30 nm at a magnification of about 100 000×.

The electrode coating comprising the aggregated silicon particles from (comparative) example 6 was tested as described in example 2.

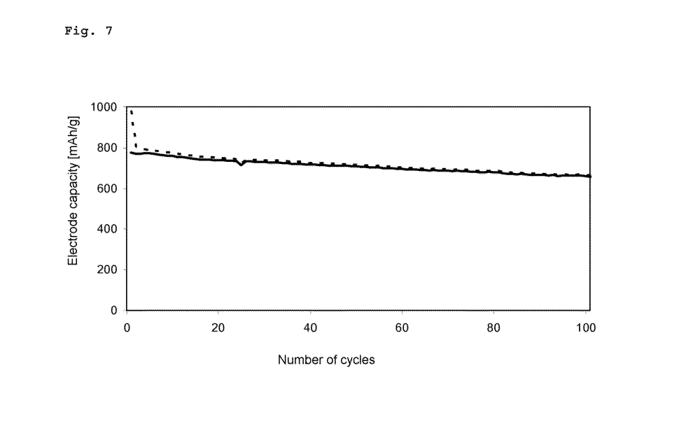

FIG. 7 shows the charging (broken line) and discharging capacity (solid line) of this electrode coating comprising the aggregated Si nanoparticles having a primary particle size of 20-30 nm from (comparative) example 6 as a function of the number of cycles at a current of 100 mA/g. The electrode coating has a reversible initial capacity of about 800 mAh/g and after 100 charging/discharging cycles still has about 85% of its original capacity.

Evaluation of the Initial Loss of Mobile Lithium

Table 1 shows the loss of mobile lithium of the materials from examples 1, 4 and (comparative) example 6 found in the first cycle.

The materials from example 1 and 4 have a lower initial Li loss compared to the material from example 6. This shows that, at otherwise the same composition of the electrode material, the use of unaggregated silicon particles leads to an unexpected technical effect.

TABLE 1
Initial loss of mobile lithium

| | Average | Initial Li loss based |
|---|---|---|
| Material | particle size | on reversible capacity |
| Example 1 | 190 nm | 15% |
| Example 4 | 150 nm | 18% |
| (Comparative) | 20-30 nm | 21% |
| example 6 | | |

1. An electrode material for lithium ion batteries, comprising
5-85% by weight of nanosize silicon particles which have fracture surfaces and a sphericity of 0.3<ψ<0.9 and are not aggregated and whose volume-weighted particle size distribution lies between diameter percentiles d₁₀>20 nm and d₉₀<2000 nm and has a width d₉₀-d₁₀ of <1200 nm;
0-40% by weight of an electrically conductive component comprising nanosize structures having dimensions of less than 800 nm;
0-80% by weight of graphite particles having a volume-weighted particle size distribution between diameter percentiles d₁₀>0.2 μm and d₉₀<200 μm;
5-25% by weight of a binder;
wherein a total proportion of graphite particles and electrically conductive component is at least 10% by weight, where proportions of all components add up to a maximum of 100% by weight.

2. The electrode material as claimed in claim 1, wherein the nanosize silicon particles are doped with foreign atoms.

3. (canceled)

4. The electrode material as claimed in claim 1, wherein the nanosize silicon particles bear covalently bound organic groups on a surface thereof.

5. The electrode material as claimed in claim 1, wherein the electrically conductive component is conductive carbon black containing primary particles which have a volume-weighted particle size distribution between diameter percentiles d₁₀>5 nm and d₉₀<200 nm.

6. The electrode material as claimed in claim 1, wherein the electrically conductive component is carbon nanotubes having a diameter of from 0.4 to 200 nm.

7. The electrode material as claimed in claim 1, wherein the electrically conductive component contains metallic nanoparticles.

8. (canceled)

9. A lithium ion battery comprising a negative electrode composed of an electrode material as claimed in claim 1.

10. (canceled)

11. The electrode material as claimed in claim 2, wherein the nanosize silicon particles bear covalently bound organic groups on a surface thereof.

12. The electrode material as claimed in claim 11, wherein the electrically conductive component is conductive carbon black containing primary particles which have a volume-weighted particle size distribution between diameter percentiles d₁₀>5 nm and d₉₀<200 nm.

13. The electrode material as claimed in claim 12, wherein the electrically conductive component is carbon nanotubes having a diameter of from 0.4 to 200 nm.

14. The electrode material as claimed in claim 13, wherein the electrically conductive component contains metallic nanoparticles.

15. A lithium ion battery comprising a negative electrode composed of an electrode material as claimed in claim 14.
